(19) United States
(12) Patent Application Publication
(10) Pub. No.: US 2026/0309290 A1
(43) Pub. Date: Oct. 8, 2026

(54) LUMINAIRE ASSEMBLY, SYSTEM AND METHOD

(71) Applicant: SIGNIFY HOLDING B.V., EINDHOVEN (NL)

(72) Inventors: GUIDO THEO MARIA LAMERICHS, HOESELT (BE); HENRICUS MATHIJS MARIA CREEMERS, EINDHOVEN (NL)

(21) Appl. No.: 19/474,744

(22) PCT Filed: Apr. 10, 2024
(86) PCT No.: PCT/EP2024/059705

§ 371 Date: Oct. 13, 2025

(30) Foreign Application Priority Data
Apr. 13, 2023 (EU) 23167687.5

(51) Int. Cl. F21S 8/08; F21V 23/00; F21W 131/103; H01Q 1/22

(52) U.S. Cl. CPC F21S 8/085; F21V 23/00; H01Q 1/22; F21W 2131/103

(57) ABSTRACT

An outdoor luminaire (1) is provided, comprising a light module (3), an RF module (5) and a canopy (7). The light module (3) is at least partly covered by the canopy (7) and comprises a light source (9) for emitting light from the luminaire (1). The RF module (5) is at least partly covered by the canopy (7) and comprises one or more antennas (21) configured for emitting and/or receiving an RF signal in a predetermined RF frequency band and along a respective signal beam path (SP). The canopy (7) comprises one or more RF windows (23) associated with the one or more antennas (21). Each antenna (21) is spaced from the associated window (23) by a reflection minimizing distance (d) and the window has a loss minimizing thickness (t).

### FIELD OF THE INVENTION

The present disclosure relates to an outdoor luminaire, in particular an outdoor luminaire for road lighting. The present disclosure further relates to a communication infrastructure which may be wireless, in particular a wireless communication infrastructure leveraging existing outdoor lighting infrastructure. The present disclosure also relates to a computer implemented method for designing a luminaire canopy for an outdoor luminaire.

### BACKGROUND OF THE INVENTION

The outdoor lighting grid (e.g. street lighting) offers a near-ideal grid to deploy wireless communication infrastructure (Wi-Fi, telecommunications 4G/5G, E-band and V-band backhaul) because it offers proximity (to people, traffic), scale (ubiquitous presence), granularity (distance between poles matches typical requirements of Radio Frequency (RF) network design) and elevation (height to mount equipment for signal coverage). One key challenge to get acceptance from cities (permits) and the public, is to provide aesthetic solutions and minimized form factors. There is a strong wish to hide technology in unseen places.

From technology point of view, this puts pressure on design of the overall RF system. Such system comprises as key building blocks: Base Band Unit (BBU), radio and antenna. For lower frequencies (below ~7 GHZ), BBU, radio (transmitter and/or receiver) and antenna can be physically separated. For higher frequencies, physical separation between radio and antenna needs to be minimized or avoided.

The ever-growing data consumption (data throughput) require higher bandwidths, which in turn requires the use of ever higher frequencies. The radio frequencies used for telecommunication's 5G standard are at first increasing to 6 GHz and will in the coming years grow to 26 GHz and beyond. These frequencies are typically referred to as mmWave (millimeter wave) because the wave lengths are in the order of (several) mm. Backhaul frequencies are typically 60 GHz, 70 GHz, and will over time grow beyond 100 GHz. Signals at these frequencies behave like optical waves in the sense that they do not penetrate walls and objects. Communication between two points requires a clear line of sight (LOS), which means the transmitter and receiver must “see” each other via an uninterrupted, unobstructed, straight line.

Hence, when integrating an RF system in an outdoor lighting grid, the radio and antenna may be arranged at least partly in a luminaire canopy to hide them at least partly from view. Then, the canopy needs to accommodate the radio and the antenna. It has been found that in such case, conflicts arise regarding demands related to one or more of size of the luminaire, thermal restrictions of the RF module and/or antenna, aesthetics of the luminaire, mounting of the antenna, RF performance and associated signal transmission. Such conflicts arise in particular in association with design of luminaires that have to conform to a particular appearance. In some cases, a compromise between the various demands can only be achieved after several iterations of mechanical engineering and RF engineering, which is time-consuming and costly.

Therefore, improvements in luminaires comprising RF antennas and in particular in designing such luminaires are desired.

EP4033143A1 discloses a luminaire comprising a light module, and a communication module accommodated within a luminaire housing.

### SUMMARY OF THE INVENTION

In view of the considerations above, herewith an outdoor luminaire is provided, comprising a light module, an RF module and a canopy. The light module is at least partly covered by the canopy and comprises a light source for emitting light from the luminaire. The RF module is at least partly covered by the canopy and comprises one or more antennas configured for emitting and/or receiving an RF signal in a predetermined RF frequency band and along a respective signal beam path. The canopy comprises one or more RF windows associated with the one or more antennas. The RF module and the canopy are arranged such that for each assembly of an antenna and an RF window associated with each other, respectively,
the RF signal beam path passes through the RF window, for transmission of the RF signal through the window,
the antenna is spaced along the signal beam path from an inner surface of the RF window by a reflection minimizing distance (d) of an odd integer times half an effective wavelength (λₘ) of the RF signal between the antenna and the window (d=((2m−1)/2)λₘ wherein m is a positive integer), and
the RF window has a loss minimizing thickness (t) along the signal beam path of an odd integer times half an effective wavelength of the signal in the window (λ_{w})(t=((2n−1)/2)λ_{w} wherein n is a positive integer).

In any embodiment herein one or more of the following may apply:

The outdoor luminaire may in particular be an outdoor road luminaire, e.g. a street lighting luminaire. The canopy may form an upper part of the luminaire. The canopy may protect the light module and the RF module from precipitation etc. The light module may comprise one or more of a light source, a reflector, and a heat sink. The light source may be provided with a power supply to power a light emitter, e.g. one or more LEDs. The luminaire may comprise an optically transparent luminaire bottom part for emitting light from the light source from the luminaire.

The RF module may be configured for wireless transmitting and/or receiving communication signals which are unrelated to the lighting function of the luminaire and/or to operation of the light module. The RF module may comprise form a transmitter and/or a receiver, preferably both. The RF module may comprise an RF modulation unit, which may comprise a modulator and/or demodulator, preferably both, and the one or more antennas may be operably connected with the RF modulation unit, each of the one or more antennas being configured to emit and/or receive the RF signal.

Each signal beam path corresponds to a direction of propagation of the phase front of the RF signal for data transmission. Preferably, each antenna is a directional antenna providing a signal beam with a controlled signal beam path and with a controlled beam shape. For each antenna, the respective signal beam path may be associated with one or more modes of operation of the respective antenna; e.g. one or more of the antennas may be a distributed antenna providing a controllable signal beam path non-normal to an antenna emitting surface. Likewise, an antenna for receiving an RF signal may be a distributed antenna for receiving an incident RF signal from a non-normal direction of incidence and/or detecting a signal beam path direction thereof.

Each of the one or more RF windows may be associated with a respective one of the one or more antennas. For each RF window, the inner surface of the RF window may also be referred to as an antenna-facing surface. The thickness of each RF window is defined between the inner surface and an outer surface opposite the inner surface along the (intended) signal beam path through that RF window. Regarding the spacing of the antenna from the inside surface of the RF window and the loss minimizing thickness of the RF window, “substantially” means a deviation of at most 10% from the specified value, preferably a deviation of at most 5% from the specified value, more preferably a deviation of at most 3% from the specified value, e.g. the specified value plus or minus 10% or less of the specified value (respectively 5% or less or 3% or less,).

The inner and outer surfaces of the one or more RF windows may be parallel to each other. One or both of the inner and outer surfaces may be normal to the signal beam path. The outer surface of one or more of the RF windows, preferably each RF window may form an outside surface member of the canopy.

The effective wavelength (λₘ) of the RF signal between the antenna and the window is the wavelength of the RF signal in the medium between the antenna and the window: λₘ=λ₀/√εᵣ with wherein λ₀ is the wavelength in vacuo and εᵣ is the dielectric constant (relative permittivity) of the medium. Generally, for air, εᵣ=1 is a good approximation. The effective wavelength of the signal in the window λ_{w} is the wavelength of the RF signal in the medium of the window: λ_{w}=λ₀/√ε_{rw} wherein λ₀ is the wavelength in vacuo and ε_{rw} is the dielectric constant (relative permittivity) at the RF frequency of the RF signal of the window material, in particular a dielectric such as a polymer substrate.

The spacing between the antenna and the inner surface of the window reduces or prevents destructive interference of the signal due to reflections of the signal on the inner surface; along the signal beam path between the antenna and the window the spacing amounts to a phase change Δφ of the RF signal of Δφ=(2m−1) π radians. This prevents that reflections cancel part of the RF wave and reduces signal quality loss and/or signal power loss of the RF signal. The loss minimizing thickness of the RF window likewise amounts to a phase change Δφ of the RF signal of Δφ=(2n−1) π radians, which reduces or prevents signal quality loss and/or signal power loss of the RF signal transmitted through the window.

The reflection minimizing distance d may be ½ times the effective wavelength (λₘ) of the RF signal between the antenna and the window (d=(½)λₘ). It is noted that The wavelength in vacuo λ₀ (also known as “nominal wavelength”) and in air of an RF signal at a frequency of 60 GHz is in the order of 5 mm. The RF window may have a loss minimizing thickness t along the signal beam path being substantially ½ times the effective wavelength of the signal in the window t=(½) λ_{w}; for most suitable dielectrics, the dielectric constant is in a range of 2.8-3.3 for RF frequencies in a range of 30-300 GHz, so that the window loss minimizing thickness may be in a range of (½)λ_{w}=λ₀/(2√ε_{rw})~0.15-1.7 mm.

The canopy may comprise an antenna mount mated to an antenna fixture of the antenna, determining, when mated, the reflection minimizing distance (d).

This may facilitate manufacturing of the luminaire, and/or assembly of the luminaire, to the desired relative position of the antenna and the RF window.

The window and the antenna mount, and possibly further canopy members may be fixed together, in particular being formed as (at least part of) a unitary whole. The unitary whole may be manufactured by permanently attaching members of the same or different materials together such as by gluing or welding. The window and the antenna mount may more in particular be a monolithic whole, the window material and the antenna mount then being of one continuous piece material, e.g. being formed as a single molded object, a single object manufactured by removal techniques such as cutting, milling, lathing, etc. or a single additive-manufactured object.

The RF window may have a curvature about the signal beam path of at least one of 10 times the effective wavelength of the signal in the window and 10 times the effective wavelength (λₘ) of the signal between the antenna and the inner window surface. Also or alternatively, the antenna defines a field of view and wherein the window is configured to span at least the field of view. The field of view may be determined by a solid angle spanned from the emission and/or detection member of the antenna by directions in which the RF signal may be emitted by the antenna and/or along which an RF signal incident on the emission and/or detection member of the antenna is detectable by the antenna. The window spanning at least the field of view allows transmission of the RF signal through the RF window without being cut-off by a window boundary and/or without causing disturbances like edge reflections.

Associated with the preceding, herein further is provided a communication system comprising plural outdoor luminaires according to any embodiment disclosed herein.

The communication system may comprise a first luminaire and a second luminaire of the plural outdoor luminaires, arranged for at least operable transmitting an RF signal from the first luminaire by the RF module of the first luminaire and receiving the RF signal in the second luminaire by the RF module of the second luminaire.

As will be appreciated by one skilled in the art, aspects of the present disclosure may be embodied as a system, a method or a computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present disclosure may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present disclosure, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present disclosure may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or member of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the considerations above, herewith is provided a computer implemented method for designing a luminaire canopy for an outdoor luminaire, comprising
a processor, preferably a microprocessor, in a computer system executing computer readable program code for:
receiving RF signal data indicative of at least one of an RF frequency and an RF wavelength of an RF signal, the RF signal being in a predetermined RF frequency band,
receiving first RF window data indicative of a position and an orientation of a first window surface of an RF window in the canopy,
receiving first signal beam path data indicative of a signal beam path of the RF signal traversing the RF window,
receiving window material data indicative of a dielectric constant (relative permittivity) of a material of the RF window for the predetermined RF frequency band, receiving first antenna data indicative of: one or more antenna fixtures relative to a position and an orientation of an emission and/or detection member of an RF antenna configured to emit and/or receive the RF signal, respectively, along the signal beam path, relative to attached to the emission and/or detection member; and
further executing computer readable program code for:
calculating second RF window data indicative of
   a position and an orientation of a second window surface of the RF window opposite the first window surface along the signal beam path, and of
   a loss minimizing thickness of the RF window from the first surface to the second surface along the signal beam path of substantially an odd integer times half an effective wavelength of the signal in the window (λ_{w})(t=(2n−1)/2λ_{w}) wherein n is a positive integer),
determining, based on at least one of the first and second RF window data, one of the first and second window surfaces as an inner window surface of the RF window on an inside of the canopy and the other one of the first and second window surfaces as an outer window surface of the RF window on an outside of the canopy, and
calculating second antenna data indicative of a position and an orientation of the one or more antenna fixtures, associated with the emission and/or detection member of the antenna being spaced along the signal beam path from the inner window surface by a reflection minimizing distance (d) of substantially an odd integer times half an effective wavelength (λₘ) of the signal between the antenna and the inner window surface (d=((2m−1)/2)λₘ wherein m is a positive integer).

The predetermined RF frequency band may be associated with the RF modulation unit and may be in a range of 30-300 GHz, preferably in a range 40-200 GHz, more preferably in range 50-100 GHz, in particular in a range of 50-75 GHz such as 57-71 GHz.

The position and orientation of a first window surface of the RF window in the canopy, and/or the a signal beam path may be in absolute numbers (spatial coordinates, distances, angles) and/or relative to one or more suitable references, e.g. relative to one or more one or more luminaire features, one or more canopy features, one or more antenna features, and the RF signal (see below).

The RF signal data and/or the window material data may be provided as one or more of a value or value range, an equation, a specification and/or a constraint to be met, a measurement result, a code, and/or any other suitable manner.

The effective wavelength (λₘ) of the RF signal between the antenna and the window is the wavelength of the RF signal in the medium between the antenna and the window: λₘ=λ₀/εεᵣ wherein λ₀ is the wavelength in vacuo and εᵣ is the dielectric constant (relative permittivity) of the medium r. Generally, for air, εᵣ=1.0 is a good approximation. The effective wavelength of the signal in the window λ_{w} is the wavelength of the RF signal in the medium of the window: λₘ=λ₀/√ε_{w} wherein λ₀ is the wavelength in vacuo and Ew is the dielectric constant (relative permittivity) at the RF frequency of the RF signal of the window material, in particular a dielectric such as a polymer substrate.

The spacing between the antenna and the inner window surface (inner surface of the window) reduces or prevents destructive interference of the signal due to reflections; along the signal beam path between the antenna and the window the spacing amounts to a phase change Δφ of the RF signal of Δφ=(2m−1) π radians. This prevents that reflections cancel part of the RF wave. Thus, signal quality loss and/or signal power loss of the RF signal are reduced or prevented. The loss minimizing thickness of the RF window likewise amounts to a phase change Δφ of the RF signal of Δφ=(2n−1) π radians, which further reduces or prevents signal quality loss and/or signal power loss of the RF signal transmitted through the window.

Any or all of the RF signal data, the first signal beam path data, the window material data, and the first antenna data may be provided to a computer implementing the method from a memory and/or be provided via a user interface to the computer. Then, when performing the method, starting from the first RF window data, the second RF window data and second antenna data are calculated, providing optimal thickness of the RF window and optimal position and orientation of the one or more antenna fixtures and hence providing optimal positioning of the antenna relative to the RF window.

Hence, a luminaire designer wishing to incorporate an RF module comprising an RF antenna in the luminaire, wherein the RF antenna is accommodated in the canopy being protected from outside influences (e.g. weather, birds and other animals, and/or being hidden from human view), need only be provided with specifications of the RF signal and the RF antenna with which the luminaire should operate, and then the designer need only select a window material and consider the position and orientation of the window surface in the luminaire canopy, to be provided mounting fixtures for fixing the antenna fixtures in the appropriate position and orientation, without requiring RF-specific knowledge. Thus, iteration steps between mechanical design and RF design may be reduced or avoided. The window material may differ from one or more materials of one or more other canopy members e.g. an RF window fitting, or the window material may be the same material as at least a member of the canopy remote from the window, e.g. the canopy may essentially be formed of a single dielectric material.

The calculated second window surface data and second antenna data may be used in a CAD and/or CAM method for designing a canopy and/or a luminaire, e.g. the data may be used for calculations associated with one or more mechanical constraints, electrical constraints and/or use constraints, e.g. related to strength, safety, manufacturability etc. The calculated second window surface data and second antenna data may be stored for future reference and/or serve as a module for incorporation in a further design, the further design conforming to the same RF signal data, first signal beam path data relative to the window surface of the further design, window material data, and first antenna data used in the method.

The method may be repeated and/or, as indicate hereinbefore, the calculated second window surface data and second antenna data may be used for one or more further RF windows in the canopy, providing associated positions and orientations of antenna fixtures of antennas associated with respective RF windows; thus (a canopy for) a luminaire for multi-directional RF signal transmission and/or reception may be provided, for use in a multi-node RF communication infrastructure.

The canopy may further be designed for covering and/or accommodating at least part of a light module, e.g. comprising a light source for emitting light from a luminaire comprising the canopy.

The method may further comprise calculating antenna mount data associated with the RF window indicative of one or more mounting fixtures fixed to the RF window mated to the one or more antenna fixtures for mounting the antenna to the RF window at the position and the orientation of the one or more antenna fixtures associated with the calculated second antenna data.

The window mounting fixtures and the window may be arranged to form an integrated whole, e.g. being monolithic, e.g. a single molded piece. This may facilitate positioning the antenna in the desired position and orientation. The mating of the fixtures may comprise mating members for positioning the antenna to the antenna mount such as mated protrusions and recesses, and/or matching holes in the antenna fixtures and antenna mounts for receiving one or more fasteners such as screws, bolts, a rivets, etc. through both the antenna fixture and antenna mount.

The method may further comprise receiving secondary media data indicative of a material of a secondary dielectric medium in the signal beam path between the antenna and the inner window surface and associated with a dielectric constant (relative permittivity) of the dielectric medium for the predetermined RF frequency band determining the effective wavelength (λₘ) of the signal between the antenna and the inner window surface based on the secondary media data and calculating the second antenna data also based on the dielectric constant (relative permittivity) of the dielectric medium.

Thus, the spacing may be accommodated to a dielectric medium in the signal beam path. This may further improve RF transmission in the signal beam path between the antenna and the inner window surface. However, it is preferred that the signal beam path between the antenna and the inner window surface is devoid of dielectric media other than air, and the dielectric constant of air may be suitably approximated with 1.0 for RF frequencies.

The method may further comprise determining a curvature of the first and/or second window surface about the signal beam path, wherein the curvature has a radius of curvature of at least 10 times the effective wavelength (λₘ) of the signal between the antenna and the inner window surface.

Such curvature for the RF window is considered to reduce or prevent disturbing an RF signal transmitted through the RF window, compared to stronger curvatures.
The method may further comprise receiving second signal beam data indicative of a signal beam size in one or more directions perpendicular to the signal beam path, and calculating at least part of the second RF window data based on the second signal beam data, wherein the second RF window data are indicative of a size and position of the second window surface larger than the signal beam size in the one or more directions perpendicular to the signal beam path.

This may ensure that the RF window is larger than an antenna field of view, to reduce or prevent edge reflections and/or other disturbances of the RF signal.

Associated with the preceding, herein further is provided a method of manufacturing a canopy for any embodiment of an outdoor luminaire as described herein, the method comprising performing the steps of any embodiment of an computer implemented method described herein and manufacturing the canopy comprising one or more of the one or more RF windows and an antenna mount in accordance with the determined second RF window data and the determined antenna mount data, respectively.

Associated with the preceding, herein further are provided
a data processing apparatus comprising a processor adapted to/configured to perform the steps of any method embodiment discussed herein;
a computer program product comprising instructions which, when the program is executed by a computer, cause the computer to carry out the steps of any method embodiment discussed herein; and
a computer-readable storage medium comprising instructions which, when executed by a computer, cause the computer to carry out the steps of any method embodiment discussed herein.

Moreover, a computer program for carrying out the methods described herein, as well as a non-transitory computer readable storage-medium storing the computer program are provided. A computer program may, for example, be downloaded (updated) to an existing computer system such as a CAD (Computer Aided Design) system and/or CAM (Computer Aided Manufacturing) system and/or be stored upon manufacturing of these systems.

Embodiments of the present disclosure will be further illustrated with reference to the attached drawings, which schematically will show embodiments. It will be understood that the present disclosure is not in any way restricted to these specific embodiments.

### BRIEF DESCRIPTION OF THE DRAWINGS

FIG. 1 is a schematic cross section representation of a luminaire comprising a light module and an RF module;

FIG. 2 is another schematic top view representation of a luminaire comprising a light module and an RF module;

FIG. 3 indicates part of a canopy provided with an RF antenna and an RF window;

FIG. 4 is indicates (partly broken away) a luminaire comprising a light module and an RF module;

FIG. 5 indicates a communication system;

FIG. 6 indicates an embodiment of a method disclosed herein;

FIG. 7 indicates a computing system, according to one embodiment of the present disclosure.

### DETAILED DESCRIPTION OF THE EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, possibly increased by hundreds between embodiments, and/or where helpful individualized with alphabetic suffixes.

Further, unless otherwise specified, terms like “detachable” and “removably connected” are intended to mean that respective parts may be disconnected essentially without damage or destruction of either part, e.g. excluding structures in which the parts are integral (e.g. welded or molded as one piece), but including structures in which parts are attached by or as mated connectors, fasteners, releasable self-fastening features, etc. The verb “to facilitate” is intended to mean “to make easier and/or less complicated”, rather than “to enable”.

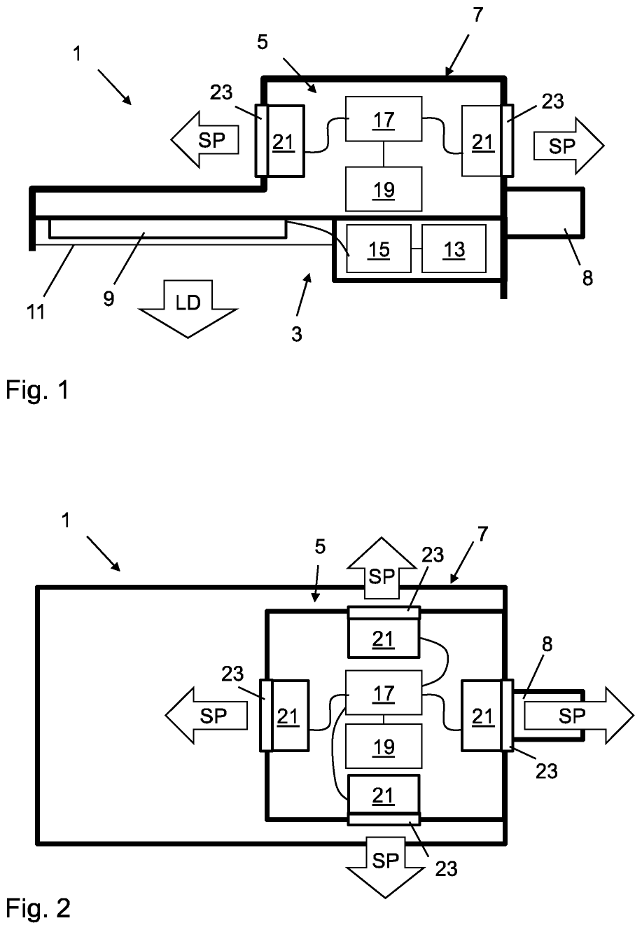

FIG. 1 and FIG. 2 are both schematic representations of a luminaire 1, which comprises a light module 3, an RF module 5, and a luminaire housing comprising a canopy 7 and a mount 8 for attachment to a support, e.g. a lamp post, not shown. The canopy 7 accommodates at least part of the light module 3 and the RF module 5, at least partly covering them and protecting at least part of the light module 3 and the RF module 5, such as protecting from environmental effects and/or from substances falling onto the luminaire, e.g. precipitation, from substances falling onto the luminaire. Also or alternatively, the canopy may at least partly hide the light module 3 and the RF module 5 from view.

The light module 3 is partly covered by the canopy 7, and comprises a light source 9 for emitting light from the luminaire 1 through an optional light exit window 11 in a light direction LD. The light source 9 may comprise or be any type of light emitter, e.g. an incandescent lamp, a gas discharge lamp, and/or or one or more LEDs, and may be provided with a power supply unit 13 and/or a light source driver 15. The light source 9 may be provided with a heat sink (not shown).

The RF module 5 is covered by the canopy 7 and comprises an RF modulation unit 17 and a power supply 19 and operably connected to one or more antennas 21 for emitting and/or receiving an RF signal in a predetermined RF frequency band, determined by the antennas 21 and the RF modulation unit 17, along a respective signal beam path SP through RF windows 23 comprised in the canopy 7. E.g., the luminaire 1 may comprise plural (e.g. two, three, four, five, six or eight) antennas 21 and RF windows 23. The antennas 21 and RF windows 23 may then be arranged to emit and/or receive RF signals into/from plural different directions (not shown) for communication with other RF sources and/or detectors such as other, possibly similar, RF modules of other, possibly similar luminaires.

One or more of the power supplies 13, 19, light source driver 15 and RF modulation unit 17 may be connected via cables (not indicated) to further devices outside of the luminaire, e.g. power grid devices and/or backhaul network devices (not indicated); the cables may pass through the mount 8.

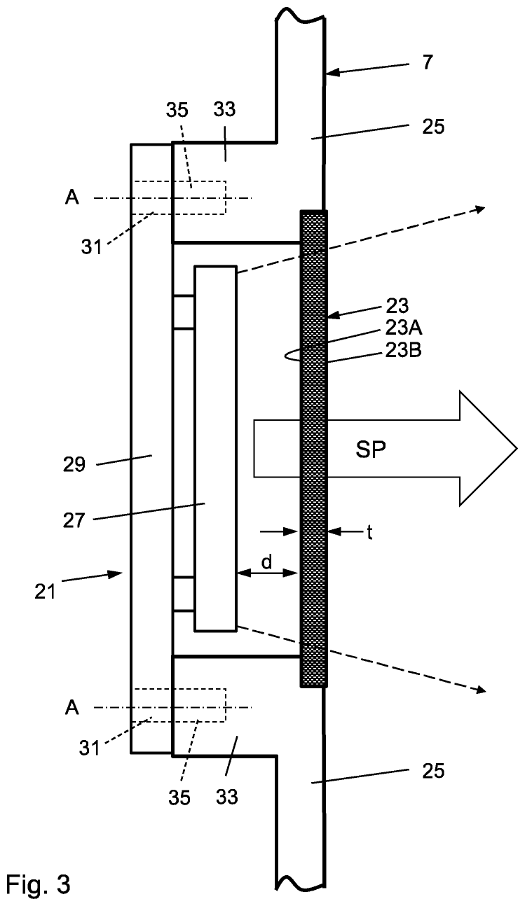

FIG. 3 schematically shows an assembly comprising an antenna 21 and an RF window 23 in a wall member 25 of the canopy 7. The RF window 23 has a first, inner, window surface 23A and a second, outer, window surface 23B. In the shown embodiment the RF window 23 is mounted to the wall member 25, being of a different material than the wall member 25. However, in other embodiments, the RF window 23 may be of the same material as the wall member 25 and possibly being monolithic with the wall member 25, which may simplify manufacture and/or increase structural robustness of the canopy, and/or may render the RF window relatively inconspicuous.

The antenna 21 has an emission and/or detection member 27, e.g. one or more metallic and/or dielectric elements generating the RF signal into air or other medium surrounding the member 27 along the signal beam path SP. The member 27 may be controlled to control a direction of the signal beam path SP emitted by the antenna 21 into a non-normal direction with respect to the member 27, and/or to detect an RF signal incident onto the antenna 21 in a non-normal direction, as indicated with dashed arrows in FIG. 3. The indicated non-normal directions may (also) define a field of view of the antenna 21 and/or a signal beam size boundary of the RF signal. The RF window 23 is configured to span at least the field of view and/or the signal beam size boundary of the RF signal, so as not to define, or interfere with, the RF signal beam. The antenna 21 preferably is controlled to provide the emitted RF signal beam with minimal divergence, e.g. to optimize beam quality and/or to optimize transmitted intensity.

The emission and/or detection member 27 is optionally fixed to an antenna support member 29. The antenna 21 comprises antenna fixtures 31 such as through holes along an axis A. In the shown embodiment, as an option, the canopy 7 is provided with antenna mounts 33 mated to the antenna fixtures 31 of the antenna 21, determining, when mated, a reflection minimizing distance d between the member 27 and the inner window surface 23A as follows: the emission and/or detection member 27 is spaced along the signal beam path SP from an inner surface 23A of the RF window 23 by the reflection minimizing distance d of an odd integer times half an effective wavelength λₘ of the RF signal between the antenna 21 (rather: the emission and/or detection member 27 thereof) and the window 23: d=((2m−1)/2)λₘ; m may be any positive integer. In particular m may be 1 so that d=½λₘ=½ λ₀/√εₘ wherein εₘ is the dielectric constant of the medium between the antenna 21 and the window 23, e.g. air with εₘ=1.0. In case of the emission and/or detection member 27 being a distributed antenna comprising multiple antenna elements together generating and/or detecting the RF signal, the reflection minimizing distance d includes the Fraunhofer distance from (the elements of) the emission and/or detection member 27. In FIG. 3, the antenna mounts 33 are fixed to the canopy wall, here being formed integral with the canopy wall 25, which may simplify manufacture. The antenna mounts 33 comprise optional holes 35 aligned with the holes of the antenna fixtures 31. Further and/or different structures for defining a position of the antenna 21, such as protrusions and or recesses mated to (at least part of) the antenna fixtures to define relative positions to a predetermined position may be provided in and/or on (antenna mounts of) a canopy as well.

Further, the RF window 23 has a loss minimizing thickness t along the signal beam path SP defined by the window surfaces 23A. 23B of an odd integer times half an effective wavelength of the signal in the window λ_{w}: t=((2n−1)/2)λ_{w}; n may be any other positive integer. In particular n may be 1 so that t=(½)λ_{w}=(½)λ₀/√ε_{w} wherein ε_{w} is the dielectric constant (or: relative permittivity) of the window material. Data for some suitable RF window materials are shown in the following Table 1. The RF window may be formed from an epoxy material such as a composite material containing fibreglass reinforced with an epoxy resign binder (G10, FR4), or a casting from thermoset epoxy polymers based on bisphenol.

| Material | Relative permittivity (εw) |
|---|---|
| ABS | 2.82 |
| PET foil | 3.24 |
| Epoxy | 3.25 |

Table 1: data for some suitable RF window materials (here ABS stands for Acrylonitrile Butadiene Styrene; PET stands for Poly-Ethylene Terephthalate; Epoxy stands for epoxy materials that are solid at environmental temperatures (e.g. from −30 to +60 degrees Celsius).

The shown RF window is plane, but it may be curved, having a curvature about the signal beam path SP of at least one of 10 times the effective wavelength (λₘ) of the signal between the antenna and the inner window surface.

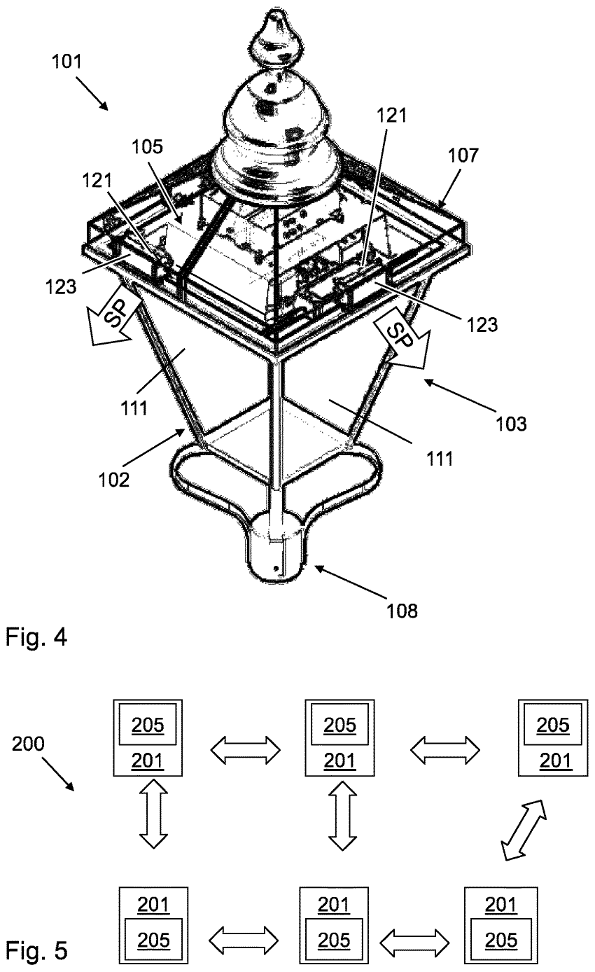

FIG. 4 indicates a further luminaire 101 as another embodiment of an outdoor luminaire disclosed herein. The further luminaire 101 is for street lighting and has a more classical lantern shape than the luminaire of FIGS. 1-3. FIG. 5 is a detail of FIG. 4.

The further luminaire 101 comprises a frame 102 supporting a light module 103 and an RF module 105. The light module 103 in turn being provided with light exit windows 111. The RF module 105 is covered by the canopy 107 and comprises an RF modulation unit 117 operably connected to plural (e.g. four) antennas 121 for emitting and/or receiving an RF signal along a respective signal beam path SP through respective RF windows 123 comprised in the canopy 107.

FIG. 5 indicates a communication system 200 comprising plural outdoor embodiments of luminaires 201 as provided herein, wherein at least some of the luminaires are arranged along one or more lines of sight with respect to each other so as to allow communication by transmission and reception of RF signals from and to, respectively, (the RF modules 205 of) the at least some of the luminaires 201 (indicated by arrows). E.g., a first luminaire 201 and a second luminaire 201 of the plural outdoor luminaires, may be arranged for at least operable transmitting an RF signal from the first luminaire by the RF module of the first luminaire and receiving the RF signal in the second luminaire by the RF module of the second luminaire. In or more of the luminaires 201, e.g. see the rightmost luminaires 201 in FIG. 5, the respective RF modules 205 may be arranged for directional transmission in an angle non-normal to an RF antenna and/or RF window of the respective luminaire.

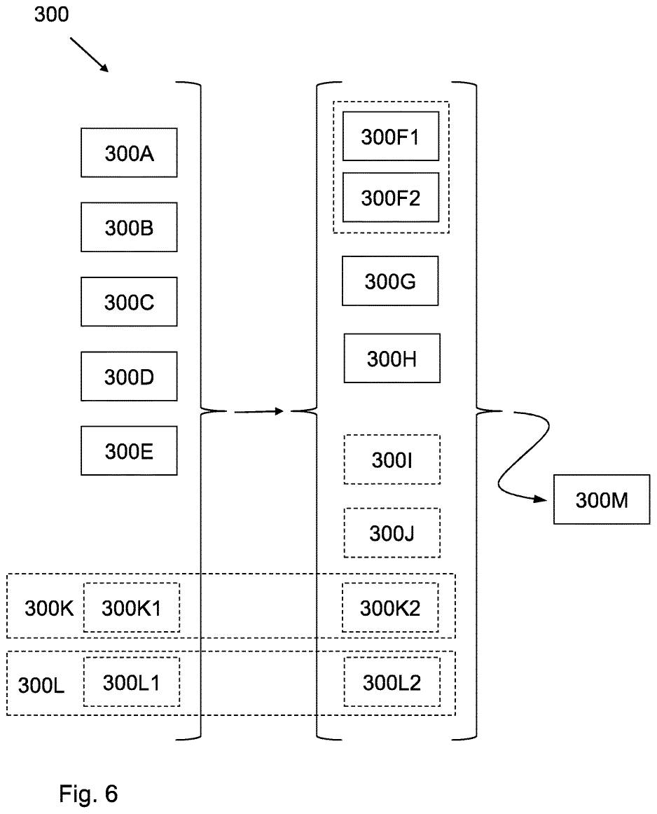

FIG. 6 indicates method steps of a computer implemented method 300 for designing a luminaire canopy for an outdoor luminaire, according to one embodiment of the present disclosure, comprising the steps of:
300A: receiving RF signal data indicative of at least one of an RF frequency and an RF wavelength of an RF signal, the RF signal being in a predetermined RF frequency band;
300B: receiving first RF window data indicative of a position and an orientation of a first window surface of an RF window in the canopy;
300C: receiving first signal beam path data indicative of a signal beam path of the RF signal traversing the RF window;
300D: receiving window material data indicative of a dielectric constant (relative permittivity) of the RF window for the predetermined RF frequency band, and
300E: receiving first antenna data indicative of one or more antenna fixtures relative to a position and an orientation of an emission and/or detection member of an RF antenna configured to emit and/or receive the RF signal, respectively, along the signal beam path, relative to attached to the emission and/or detection member.

Two or more of the respective steps 300A-300E may be done sequential, or at least partly simultaneously and/or at least partly in a combined step, e.g. by supplying to the computer a data set comprising the data of the two or more of the respective steps 300A-300E.

The method 300 then further comprises the steps of:
300F: calculating second RF window data indicative of
   (300F1) a position and an orientation of a second window surface of the RF window opposite the first window surface along the signal beam path, and of
   (300F2) a loss minimizing thickness of the RF window from the first surface to the second surface along the signal beam path of substantially an odd integer times half an effective wavelength of the signal in the window λ_{w}: t=(2n−1)/2λ_{w} wherein n is a positive integer);
300G: determining, based on at least one of the first and second RF window data, one of the first and second window surfaces as an inner window surface of the RF window on an inside of the canopy and the other one of the first and second window surfaces as an outer window surface of the RF window on an outside of the canopy; and
300H: calculating second antenna data indicative of a position and an orientation of the one or more antenna fixtures, associated with the emission and/or detection member of the antenna being spaced along the signal beam path from the inner window surface by a reflection minimizing distance d of an odd integer times half an effective wavelength λₘ of the signal between the antenna and the inner window surface: d=((2m−1)/2)λₘ wherein m is a positive integer.

The method may further comprise one or more of the optional steps of:
300I: calculating antenna mount data associated with the RF window indicative of one or more mounting fixtures fixed to the RF window mated to the one or more antenna fixtures for mounting the antenna to the RF window at the position and the orientation of the one or more antenna fixtures associated with the calculated second antenna data;
300J: determining a curvature of the first and/or second window surface about the signal beam path, wherein the curvature has a radius of curvature of at least 10 times the effective wavelength (λₘ) of the signal between the antenna and the inner window surface;
300K: (300K1) receiving secondary media data indicative of a material of a secondary dielectric medium in the signal beam path between the antenna and the inner window surface and associated with a dielectric constant (relative permittivity) of the dielectric medium for the predetermined RF frequency band determining the effective wavelength (λₘ) of the signal between the antenna and the inner window surface based on the secondary media data, and (300K2) calculating the second antenna data also based on the dielectric constant (relative permittivity) of the dielectric medium;
300L: (300L1): receiving second signal beam data indicative of a signal beam size in one or more directions perpendicular to the signal beam path, and (300L2) calculating at least part of the second RF window data based on the second signal beam data, wherein the second RF window data are indicative of a size and position of the first and second window surfaces larger than the signal beam size in the one or more directions perpendicular to the signal beam path.

In a subsequent method step 300M, a canopy may be manufactured comprising the RF window having the first and second window surfaces, the loss minimizing thickness, and the position and orientation associated with at least steps 300B-300D and 300F-330H.

The canopy may also comprise one or more of the mounting fixtures, the RF window curvature, and the RF window size associated with the respective step or steps of steps 300I-300L. The canopy may be provided with the antenna. In addition, a luminaire according to the present concepts may be provided comprising this canopy.

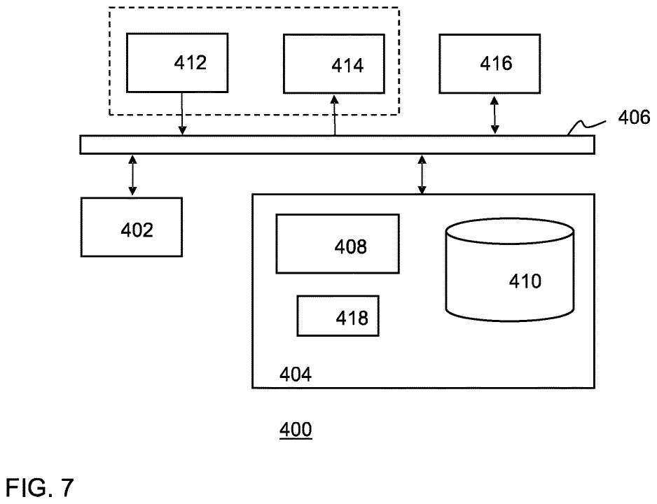

FIG. 7 depicts a block diagram illustrating an exemplary data processing system that may be used in a computing system.

As shown in FIG. 7, the data processing system 400 may include at least one processor 402 coupled to memory elements 404 through a system bus 406. As such, the data processing system may store program code within memory elements 404. Further, the processor 402 may execute the program code accessed from the memory elements 404 via a system bus 406. In one aspect, the data processing system may be implemented as a computer that is suitable for storing and/or executing program code. It should be appreciated, however, that the data processing system 400 may be implemented in the form of any system including a processor and a memory that is capable of performing the functions described within this specification.

The memory elements 404 may include one or more physical memory devices such as, for example, local memory 408 and one or more bulk storage devices 410. The local memory may refer to random access memory or other non-persistent memory device(s) generally used during actual execution of the program code. A bulk storage device may be implemented as a hard drive or other persistent data storage device. The processing system 400 may also include one or more cache memories (not shown) that provide temporary storage of at least some program code in order to reduce the number of times program code must be retrieved from the bulk storage device 410 during execution.

Input/output (I/O) devices depicted as an input device 412 and an output device 414 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 4 with a dashed line surrounding the input device 412 and the output device 414). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 416 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 400, and a data transmitter for transmitting data from the data processing system 400 to said systems, devices and/or networks. Modems, cable modems, and Ethernet cards are examples of different types of network adapter that may be used with the data processing system 400.

As pictured in FIG. 7, the memory elements 404 may store an application 418. In various embodiments, the application 418 may be stored in the local memory 408, the one or more bulk storage devices 410, or apart from the local memory and the bulk storage devices. It should be appreciated that the data processing system 400 may further execute an operating system (not shown in FIG. 4) that can facilitate execution of the application 418. The application 418, being implemented in the form of executable program code, can be executed by the data processing system 400, e.g., by the processor 402. Responsive to executing the application, the data processing system 400 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 402 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. An outdoor luminaire comprising a light module, an RF module, and a canopy,
wherein the light module is at least partly covered by the canopy and comprises a light source for emitting light from the luminaire,
wherein the RF module is at least partly covered by the canopy and comprises one or more antennas configured to emit and/or receive an RF signal in a predetermined RF frequency band along a respective signal beam path,
wherein the canopy comprises one or more RF windows associated with the one or more antennas,
wherein the RF module and the canopy are arranged such that for each assembly of an antenna and an RF window associated with each other, respectively,
the RF signal beam path passes through the RF window,
the antenna is spaced along the signal beam path from an inner surface of the RF window by a reflection minimizing distance of an odd integer times half an effective wavelength of the RF signal between the antenna and the window, wherein d=((2m−1)/2)λₘ wherein m is a positive integer, and
the RF window has a loss minimizing thickness along the signal beam path being substantially of an odd integer times half an effective wavelength of the signal in the window, wherein t=((2n−1)/2)λ_{w} wherein n is a positive integer, and
wherein the RF window has a radius of curvature about the signal beam path of at least one of 10 times the effective wavelength of the signal in the window and 10 times the effective wavelength of the signal between the antenna and the inner window surface.

2. The outdoor luminaire according to claim 1,
wherein the canopy comprises an antenna mount mated to an antenna fixture of the antenna, determining, when mated, the reflection minimizing distance (d).

3. The outdoor luminaire according to claim 1,
wherein the RF window and the antenna mount and possibly one or more further canopy members are fixed together.

4. The outdoor luminaire according to claim 1, wherein the antenna defines a field of view and wherein the RF window is configured to span at least the field of view.

5. A communication system comprising a plurality of outdoor luminaires according to claim 1.

6. The communication system according to claim 5, comprising a first luminaire and a second luminaire of the plural outdoor luminaires, arranged for at least operable transmitting an RF signal from the first luminaire by the RF module of the first luminaire and receiving the RF signal in the second luminaire by the RF module of the second luminaire.

7. A computer implemented method for designing a luminaire canopy for an outdoor luminaire, comprising:
a processor of a computer system configured to:
receive RF signal data indicative of at least one of an RF frequency and an RF wavelength of an RF signal, the RF signal being in a predetermined RF frequency band,
receive first RF window data indicative of a position, an orientation and of a first window surface of an RF window in the canopy,
receive first signal beam path data indicative of a signal beam path of the RF signal traversing the RF window,
receive window material data indicative of a dielectric constant (relative permittivity) of the RF window for the predetermined RF frequency band,
receive first antenna data indicative of one or more antenna fixtures relative to a position and an orientation of an emission and/or detection member of an RF antenna configured to emit and/or receive the RF signal, respectively, along the signal beam path,
and
calculate second RF window data indicative of,
a position and an orientation of a second window surface of the RF window opposite the first window surface along the signal beam path, and of,
a loss minimizing thickness of the RF window from the first surface to the second surface along the signal beam path of substantially an odd integer times half an effective wavelength of the signal in the RF window, wherein t=(2n−1)/2λ_{w}, wherein n is a positive integer,
determine, based on at least one of the first and second RF window data, one of the first and second window surfaces as an inner window surface of the RF window on an inside of the canopy and the other one of the first and second window surfaces as an outer window surface of the RF window on an outside of the canopy,
calculate second antenna data indicative of a position and an orientation of the one or more antenna fixtures, associated with the emission and/or detection member of the antenna being spaced along the signal beam path from the inner window surface by a reflection minimizing distance of an odd integer times half an effective wavelength of the signal between the antenna and the inner window surface, wherein d=((2m−1)/2)λₘ, wherein m is a positive integer, and
determine a curvature of the first and/or second window surface about the signal beam path, wherein the curvature has a radius of curvature of at least one of 10 times the effective wavelength of the signal in the window and 10 times the effective wavelength of the signal between the antenna and the inner window surface.

8. The method according to claim 7, further comprising:
calculating antenna mount data associated with the RF window indicative of one or more mounting fixtures fixed to the RF window mated to the one or more antenna fixtures for mounting the antenna to the RF window at the position and the orientation of the one or more antenna fixtures associated with the calculated second antenna data.

9. The method according to claim 7, further comprising:
receiving secondary media data indicative of a material of a secondary dielectric medium in the signal beam path between the antenna and the inner window surface and associated with a dielectric constant of relative permittivity of the dielectric medium for the predetermined RF frequency band determining the effective wavelength of the signal between the antenna and the inner window surface based on the secondary media data and
calculating the second antenna data also based on the dielectric constant (relative permittivity) of the dielectric medium.

10. The method according to claim 7, further comprising:
receiving second signal beam data indicative of a signal beam size in one or more directions perpendicular to the signal beam path, and
calculating at least part of the second RF window data based on the second signal beam data, wherein the second RF window data are indicative of a size and position of the first and second window surfaces larger than the signal beam size in the one or more directions perpendicular to the signal beam path.

11. The method according to claim 7, further comprising:
manufacturing the canopy comprising one or more of the one or more RF windows and an antenna mount in accordance with the determined second RF window data and the determined antenna mount data, respectively.

12. (canceled)

13. A non-transitory computer readable medium comprising instructions which, when the instructions are executed by a computer, cause the computer to carry to perform the method of claim 7.

14. (canceled)
